(19) United States
(12) Patent Application Publication
(10) Pub. No.: US 2016/0005078 A1
(43) Pub. Date: Jan. 7, 2016

(54) TERMINAL, SERVER, SYSTEM COMPRISING THE SAME, CONTROL METHOD THEREOF AND COMPUTER READABLE MEDIUM HAVING COMPUTER PROGRAM RECORDED THEREFOR

(71) Applicant: SK Planet Co., Ltd., Seongnam-si (KR)

(72) Inventor: Seung Won NA, Seoul (KR)

(21) Appl. No.: 14/789,416

(22) Filed: Jul. 1, 2015

(30) Foreign Application Priority Data
Jul. 2, 2014 (KR) 10-2014-0082259
Jul. 30, 2014 (KR) 10-2014-0096974

(51) Int. Cl. G06Q 30/02

(52) U.S. Cl. CPC G06Q 30/0261; G06Q 30/0235; G06Q 30/0256; G06Q 30/0269

(57) ABSTRACT

The present invention provides a terminal and a server, a system including the same, a control method thereof, and a computer readable medium having a computer program. The present invention can provide an efficient promotion in a specific area by sending out a pre-registered coupon and relevant product coupons corresponding to the coupon to a terminal sensed in a predetermined section, increase sale with additional promotions of relevant products, provides a function of managing poor stock, and improve usability as an offline promotion based on a beacon collection system. Further, present invention provides store information corresponding to a searched product on the basis of the price when the product is searched, additional services, the distance to move for purchasing, a royalty program of an additional discount and a mileage, information about stores having relevant products, and the like, and provides navigation information about a specific store selected by a user.

### CROSS-REFERENCE TO RELATED APPLICATIONS

This application claims the benefit of priority to Korean Application Nos. 10-2014-0082259, filed on Jul. 2, 2014 and 10-2014-0096974, filed on Jul. 30, 2014 with the Korean Intellectual Property Office, the disclosures of which are incorporated herein by reference.

### BACKGROUND OF THE INVENTION

1. Field of the Invention

The present invention relates to a terminal and a server, a system including the terminal and the server, a method of controlling the system, and a recording medium having a computer program. More particularly, the present invention relates to a terminal and a server that send out a pre-registered coupon and relevant product coupons corresponding to the coupon to a terminal sensed in a predetermined section, a system including the terminal and the server, a method of controlling the system, and a recording medium having a computer program.

Further, the present invention relates to a terminal and a server that provide information about one or more stores corresponding to a searched product on the basis of the price when the product is searched, additional services, the distance to move for purchasing, a royalty program of an additional discount and a mileage, information about stores having relevant products, and the like, and that provide a navigation service for a specific store selected by a user from the information about one or more stores, a system including the terminal and the server, a method of controlling the system, and a recording medium having a computer program.

2. Description of the Related Art

A coupon issue system is a system that sends out pre-registered coupons to terminals fitting to the predetermined standards.

According to such a coupon issue system, a user of the terminal that received a corresponding coupon has to visit a store that accepts the coupon and use the corresponding coupon within the term of validity of the coupon, so if the validity has expired, a coupon may be meaningless for a user who visited a store with a terminal receiving the coupon.

Further, a product recommendation system is a system that recommends products for a product searched by a user on the basis of other users' reviews for the corresponding product and the price information of the corresponding product.

Since the product recommendation system recommends products on the basis of only other users' reviews for a product and the price information of the product, showrooming increases and competitiveness of offline stores reduces.

### PRIOR ART DOCUMENT

### Patent Document

Korean Patent NO: 10-1317452 [Title: Location based system to deliver targeted content messages to mobile device]

Korean Patent Publication No. 10-2013-0103247 [Title: Location based product searching service method and server]

### SUMMARY OF THE INVENTION

An object of the present invention is to provide a terminal and server that send out a pre-registered coupon and a relevant product coupon corresponding to the coupon to a terminal sensed in a predetermined section, a system including the terminal and a server, a method of controlling the system, and a recording medium having a computer program.

Another object of the present invention is to provide a terminal and a server that provide information about one or more stores corresponding to a searched product on the basis of the price when the product is searched, additional services, the distance to move for purchasing, a royalty program of an additional discount and a mileage, information about stores having relevant products, and the like, a system including the terminal and the server, a method of controlling the system, and a recording medium having a computer program.

Another object of the present invention is to provide a terminal and a server that provide a navigation service for a specific store selected by a user from the provided information about one or more stores, a system including the terminal and the server, a method of controlling the system, and a recording medium having a computer program.

According to an aspect of the present invention, a content management system may include: a storage unit that keeps a plurality of coupons and a plurality of relevant product coupons; a sensing unit that senses a terminal entering a predetermined section; a communication unit that communicates with the sensed terminal, receives identification information transmitted from the terminal, and transmits the received identification information of the terminal to a could system; and a control unit that, on the basis of individual information transmitted from the cloud system in response to the transmitted identification information of the terminal, checks a coupon corresponding to the received individual information in the kept coupons, issues the checked coupon to the terminal, and additionally issues one or more relevant product coupons, which correspond to the coupon issued to the terminal, to the terminal.

As an example of the present invention, the control unit may issue a coupon corresponding to age and sex included in the individual information in the kept coupons to the terminal.

As an example of the present invention, the control unit may issue the one or more relevant product coupons right after the coupon corresponding to the individual information is issued, or may issue the one or more relevant product coupons together with the coupon corresponding to the individual information, or may issue the one or more relevant product coupons before a predetermined date from an expiration date of the coupon on the basis of the term of validity of the coupon corresponding to the individual information.

According to another aspect of the present invention, a terminal may include: a GPS receiving unit that generates current location information of the terminal; a storage unit that keeps discount coupon information and discount card information; a communication unit that communicates with a server; a control unit that, when receiving a product name of a product, transmits the product name, discount coupon or discount card information kept in advance in the storage unit in connection with the product name, current location information of the terminal, and identification information of the terminal to the server, and that receives a plurality of items of store information searched in correspondence to the product name transmitted from the server and a plurality of items of other store information searched in correspondence to relevant products relating to the product name; and a display unit that the received store information searched in correspondence to the product name and the other store information searched in correspondence to relevant products relating to the product name.

As an example of the present invention, the store information or the other store information may include at least one of store names, one or more product names or product information in stores, identification information of stores, image information about stores, location information of stores, phone number information of stores, and homepage addresses of stores.

As an example of the present invention, when one item of store information is selected from the store information searched in correspondence to the product name and the other store information searched in correspondence to relevant products relating to the product name, which are displayed on the display unit, the control unit may search a path on the basis of the selected store information and current location information of the terminal checked in real time through the GPS receiving unit, and controls the display unit to display the result of searching a path.

According to an aspect of the present invention, a server may include; a storage unit that keeps one or more items of store information; a communication unit that receives a product name of a product transmitted from a terminal, discount coupon or discount card information relating to the product, location information of the terminal, and identification information of the terminal; and a control unit that searches a plurality of items of store information in the store information kept in the storage unit on the basis of the received product name, the discount coupon or discount card information relating to the product, location information of the terminal, price information of the product corresponding to the product name, royalty program information, additional service information, and a distance, and searches a plurality of items of other store information corresponding to the relevant products relating to the product in the store information kept in the storage unit.

As an example of the present invention, the control unit may search a plurality of items of store information in one or more items of store information in a section corresponding to location information of the terminal in the store information kept in the storage unit on the basis of the received product name, the discount coupon or discount card information relating to the product, price information of the product corresponding to the product name, royalty program information, additional service information, and a distance.

As an example of the present invention, the communication unit may transmit a plurality of items of store information search in correspondence to the product name and a plurality of items of other store information searched in correspondence to the relevant products relating to the product name to the terminal.

The present invention can provide an efficient promotion in a specific area by sending out a pre-registered coupon and relevant product coupons corresponding to the coupon to a terminal sensed in a predetermined section, increase sale with additional promotions of relevant products, provides a function of managing poor stock, and improve usability as an offline promotion based on a beacon collection system.

Further, the present invention provides information about one or more stores corresponding to a searched product on the basis of the price when the product is searched, additional services, the distance to move for purchasing, a royalty program of an additional discount and a mileage, and information about stores having relevant products, so the present invention can be used for a recommendation system in an offline store and allows cross-selling among stores.

Further, the present invention provides a navigation service for a specific store selected by a user from the information about one or more stores, so it is possible to measure foot traffic of all of users in a specific area or in a wide region and use the measured data for target marketing.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating the configuration of a system according to an embodiment of the present invention.

FIG. 2 is a block diagram illustrating the configuration of a terminal according to an embodiment of the present invention.

FIG. 3 is a block diagram illustrating the configuration of a content management system according to an embodiment of the present invention.

FIG. 4 is a flowchart illustrating a method of controlling a system according to an embodiment of the present invention.

FIG. 5 is a block diagram illustrating the configuration of a system according to an embodiment of the present invention.

FIG. 6 is a block diagram illustrating the configuration of a terminal according to an embodiment of the present invention.

FIG. 7 is a block diagram illustrating the configuration of a server according to an embodiment of the present invention.

FIG. 8 is a flowchart illustrating a method of controlling a system according to an embodiment of the present invention.

FIG. 9 is a store information search image according to an embodiment of the present invention.

### DETAILED DESCRIPTION OF THE EMBODIMENTS

Terminologies used in the specification are used to explain particular embodiments and are not intended to limit the scope of the invention. In addition unless stated specifically otherwise in the specification, the terminologies used in the specification should be construed to have meanings generally understood by those skilled in the art but should not be construed to have unduly exaggerated or reduced meanings. In addition, even if the terminologies used in the specification are incorrect terminologies in expressing the idea of the present invention, these incorrect terminologies should be replaced with correct terminologies so that those skilled in the art can correctly understand the present invention. Moreover, general terms used in the specification should be construed as defined in the dictionary or according to the context and should not be construed to have unduly reduced meanings.

Hereinafter, preferred embodiments of the present invention will be described in detail with reference to the accompanying drawings so that those skilled in the art can easily practice the preferred embodiments. Throughout the drawings, the same or similar elements are denoted by the same reference numerals and explanation of which will not be repeated for the purpose of brevity of description. In the following detailed description of the present invention, concrete description on related functions or constructions will be omitted if it is deemed that the functions and/or constructions may unnecessarily obscure the gist of the present invention. Accordingly, embodiments described in the specification and elements illustrated in the drawings are illustrative only and do not cover all of the technical ideas of the present invention. It should be, therefore, understood that these embodiments and elements may be replaced with different equivalents and modifications at the point of time of filing the present application.

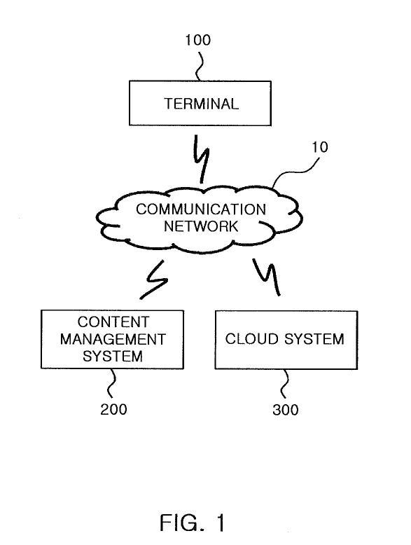

FIG. 1 is a block diagram illustrating the configuration of a system 10 according to an embodiment of the present invention.

As illustrated in FIG. 1, the system 10 includes a terminal 100, a content management system (CSM) 200, and a cloud system 300. The components of the system 10 illustrated in FIG. 1 are not all necessary components, and the system 10 may be composed of components much or less than the components illustrated in FIG. 1.

The content management system 200 that is disposed in a predetermined section senses the terminal 100 entering the corresponding section and transmits identification information of the sensed terminal 100 to the cloud system 300. Further, the content management system 200 receives individual information transmitted from the cloud system 300 in response to the transmitted identification information of the terminal 100 and issues a coupon corresponding to the received individual information to the corresponding terminal 100. Further, the content management system 200 additionally issues predetermined one or more relevant product coupon to the terminal 100 corresponding to the coupon issued to the terminal 100. Further, the corresponding terminal 100 registers the coupon and one or more relevant product coupon issued from the content management system 200.

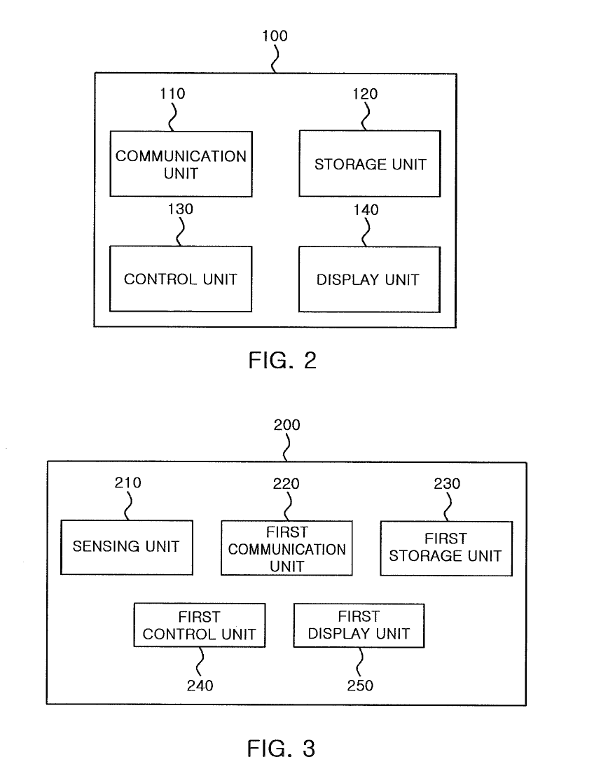

As illustrated in FIG. 2, the terminal 100 includes a communication unit 110, a storage unit 120, a control unit 130, and a display unit 140. The components of the terminal 100 illustrated in FIG. 2 are not all necessary components, and the terminal 100 may be composed of components much or less than the components illustrated in FIG. 2.

The communication unit 110 communicates with the content management system 200 and the cloud system 300 in wire/wireless communication type.

Further, the communication unit 110 is controlled by the control unit 130 to receive a coupon issued from the content management system 200.

The storage unit 120 keeps data and programs for operation of the terminal 100.

Further, the storage unit 120 is controlled by the control unit 130 to register (keep) a coupon issued from the content management system 200.

The control unit 130 controls the entire function of the terminal 100.

Further, when the terminal 100 enters (is positioned) in any one of a plurality of predetermined sections, the control unit 130 communicates with the content management system 200 in the corresponding section through the communication unit 110.

Further, the control unit 130 transmits identification information of the terminal to the content management system 200 in the corresponding section through the communication unit 110.

Further, the control unit 130 registers a coupon, which is issued from the corresponding content management system 200 in response to the transmitted identification information of the terminal 100, on the terminal 100 through a pre-installed application (not illustrated). In this process, the control unit 130 may register (or keep) a coupon, which is issued from the corresponding content management system 200 in response to the transmitted identification information of the terminal 100, on the storage unit 120.

Further, the control unit 130 additionally receives one or more relevant product coupons, which relates to the issued coupon, from the corresponding content management system 200 and registers them through a corresponding application.

Further, the control unit 130 displays the issued coupon and one or more relevant product coupons relating to the corresponding coupon on the display unit 140 through a corresponding application.

Further, the control unit 130 uses the issued coupon and one or more relevant product coupons at a store (not illustrated) corresponding to the coupon or the one or more relevant product coupons.

The display unit 140 can be controlled by the control unit 130 to display contents such as a menu image, using a user interface and a graphic user interface in the storage unit 120. Herein, the contents that are displayed on the display unit 130 include a text or image data (including various data) and an icon, and a menu screen including a list menu and a combo box. Further, the display unit 140 may be a touch screen.

Further, the display unit 140 is controlled by the control unit 130 to display an application execution image.

Further, the display unit 140 is controlled by the control unit 130 to display a coupon and one or more relevant product coupons that are issued from the content management system 200.

As illustrated in FIG. 3, the content management system 200 includes a sensing unit 210, a first communication unit 220, a first storage unit 230, a first control unit 240, and a first display unit 250. The components of the content management system 200 illustrated in FIG. 3 are not all necessary components, and the content management system 200 may be composed of components much or less than the components illustrated in FIG. 3.

The sensing unit 210 is disposed (or installed/configured) in any one of a plurality of predetermined sections.

Further, the sensing unit 210 senses the terminal 100 entering (or positioned in) any one of a plurality of predetermined sections.

That is, the sensing unit 210 senses the terminal 100 entering a predetermined section on the basis of GPS information and LBS information.

The first communication unit 220 communicates with the terminal 100 and the cloud system 300 in wire/wireless communication type.

Further, the first communication unit 220 is controlled by the first control unit 240 to communicate with the terminal 100 sensed by the sensing unit 210.

Further, the first communication unit 220 is controlled by the first control unit 240 to receive identification information of the terminal 100 transmitted from the terminal 100. Herein, the identification information of the terminal 100 includes an MDN (Mobile Directory Number), a mobile IP, a mobile MAC, specific information of a SIM (subscriber identity module) card, and a serial number.

Further, the first communication unit 220 is controlled by the first control unit 240 to transmit the identification information of the terminal 100 sensed by the sensing unit 210 to the cloud system 300.

The first storage unit 230 keeps data and programs for operation of the content management system 200.

Further, the first storage unit 230 is controlled by the first control unit 240 to keep information about the section including the corresponding content management system 200.

Further, the first storage unit 230 is controlled by the first control unit 240 to keep the identification information of the terminal 100 transmitted from the terminal 100.

Further, the first storage unit 230 is controlled by the first control unit 240 to keep the kind and the number of issue of a coupon issued to the terminal 100.

Further, the first storage unit 230 is controlled by the first control unit 240 to keep stock management information of items in a store managed by the corresponding content management system 200.

Further, the first storage unit 230 is controlled by the first control unit 240 to keep a coupon in cooperation with the stock management information and relevant product coupon corresponding to the coupon.

The first control unit 240 controls the entire function of the content management system 200.

Further, the first control unit 240 performs a stock management function on the entire item in the store (not illustrated) where the content management system 200 is disposed (or installed).

Further, the first control unit 240 performs a push message sending function for sending out a promotion (or sending out a coupon).

Further, the first control unit 240 sets (or matches) a promotion (or a coupon) corresponding to individual information.

That is, the first control unit 240 finds out promotion objects and a list of carried-forward products through the stock management, selects products for which coupons are to be sent out on the basis of the found-out information, and sets coupons corresponding to the selected products.

Further, the first control unit 240 sets one or more relevant product promotions (or relevant product coupons) corresponding to the promotion (or coupon).

That is, the first control unit 240 analyzes products that were sold the most in connection with the corresponding product when a specific product (or commodity) was sold, select one or more relevant products corresponding to the product analysis result, and sets relevant product coupons corresponding to the selected relevant products.

Further, the first control unit 240 performs a customer management function on terminals purchasing commodities in a store (or user information of terminals).

Further, the first control unit 240 transmits the identification information of the terminal 100 sensed by the sensing unit 210 to the cloud system 300 through the first communication unit 220.

Further, the first control unit 240 receives the individual information, which is transmitted from the cloud system 300 in response to the transmitted identification information of the terminal 100, through the first communication unit 220. Herein, the individual information may be individual information corresponding to the identification information of the terminal in the individual information of terminals (or identification information of terminals) kept in advance in the cloud system 300. Further, the corresponding individual information includes information such as age and sex.

Further, the first control unit 240 issues a coupon corresponding to the received individual information in a plurality of coupons kept in advance in the first storage unit 230 to the corresponding terminal 100 through the first communication unit 220.

Further, the first control unit 240 additionally issues one or more relevant product coupons kept in advance in the first storage unit 230 to the terminal 100 through the first communication unit 220 in response to the coupon issued to the terminal 100.

That is, right after a coupon corresponding to the individual information is issued to the terminal 100, the first control unit 240 additionally issues one or more relevant product coupons relating to the coupon to the terminal 100 through the first communication unit 220.

Further, when a coupon corresponding to the individual information is issued to the terminal 10, the first control unit 240 issues the coupon and one or more relevant product coupons relating to the coupon to the terminal 100 through the first communication unit 220.

Further, after a coupon corresponding to the individual information is issued to the terminal 100, the first control unit 240 issues one or more relevant product coupons relating to the corresponding coupon to the corresponding terminal 100 through the first communication unit 220, before a predetermined date from the expiration date of the coupon on the basis of the term of validity of the coupon corresponding to the individual information.

Further, the first control unit 240 uses (or performs paying functions on) the corresponding coupon and relevant product coupons issued to the terminal 100 in cooperation with the terminal 100 and a POS terminal (not illustrated) or the cloud system (or the server) 300.

The first display unit 250 can be controlled by the first control unit 240 to display contents such as a menu image, using a user interface and a graphic user interface in the first storage unit 230. Herein, the contents that are displayed on the first display unit 250 include a text or image data (including various data) and an icon, and a menu screen including a list menu and a combo box. Further, the first display unit 250 may be a touch screen.

Further, the first display unit 250 is controlled by the first control unit 240 to display the information about the terminal 100 sensed by the sensing unit 210 (for example, including the identification information of the terminal 100).

Further, the first display unit 250 is controlled by the first control unit 240 to display the coupon and one or more relevant product coupons relating to the coupon which was issued to the terminal 100.

The cloud system (or the server) 300 keeps individual information of terminals (or identification information of terminals).

Further, the cloud system 300 receives the identification information of the terminal 100 transmitted from the content management system 200.

Further, the cloud system 300 checks individual information corresponding to the received identification information of the terminal 100 in a plurality of items of individual information kept in advance (for example, including an age and sex).

Further, the cloud system 300 transmits the checked individual information to the content management system 200 in response to the received identification information of the terminal 100.

As described above, it is possible to send out a pre-registered coupon and relevant product coupons corresponding to the corresponding coupon to the terminal sensed in a predetermined section.

A method of controlling a system according to the present invention will be described hereafter in detail with reference FIGS. 1 to 4.

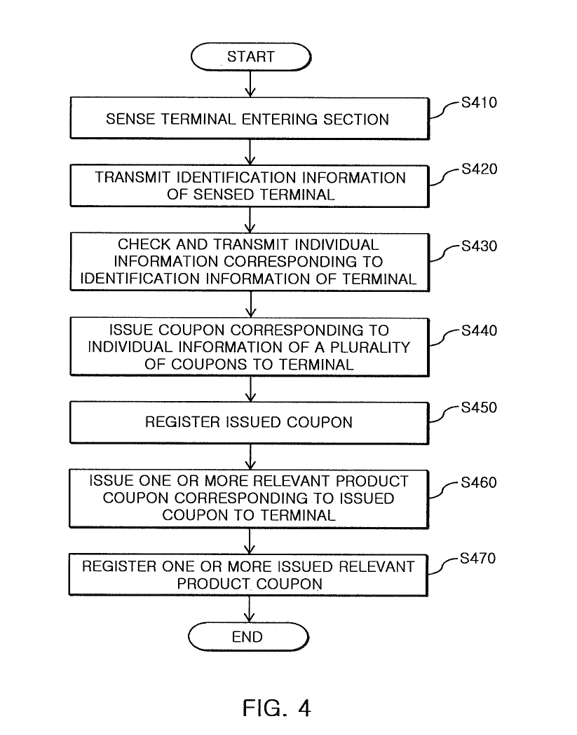

FIG. 4 is a flowchart illustrating a method of controlling a system according to an embodiment of the present invention.

First, the content management system 200 senses a terminal 100 entering (or positioned in) the section (or region) where the corresponding content management system 200 is. Herein, the section may be any one of a plurality of predetermined sections.

For example, the content management system 200 senses a terminal entering a section C, which is set to the corresponding content management system 200, in a plurality of sections (for example, including a section A, a section B, a section C, a section D, a section E, and a section F) (S410).

Thereafter, the content management system 200 transmits identification information of the sensed terminal 100 to the cloud system (or a server) 300. Herein, the identification information of the terminal 100 includes an MDN, a mobile IP, a mobile MAC, specific information of the Sim card, and a serial number.

For example, the content management system 200 communicates with the terminal 100 entering the section C and transmits the identification information of the terminal 100 transmitted from the corresponding terminal 100 to the cloud system 300 (S420).

Thereafter, the cloud system 300 receives the identification information of the terminal 100 transmitted from the content management system 200.

Further, the cloud system 300 checks individual information corresponding to the received identification information of the terminal 100 in a plurality of items of individual information kept in advance (for example, including an age and sex), and transmits the checked individual information to the content management system 200.

For example, the cloud system 300 checks individual information (for example, female and twenties) corresponding to the received identification information of the terminal 100 in individual information of a plurality of terminals kept in advance. Thereafter, the cloud system 300 transmits the checked individual information (for example, female and twenties) to the content management system 200 in response to the received identification information of the terminal 100 (S430).

Thereafter, the content management system 200 receives the individual information that is transmitted from the cloud system 300 in response to the transmitted identification information of the terminal 100.

Further, the content management system 200 issues a coupon corresponding to the received individual information in a plurality of coupons kept in advance to the corresponding terminal 100.

For example, the content management system 200 issues a blue jean discount coupon corresponding to the received individual information (for example, female and twenties) in a plurality of coupons kept in advance to the corresponding terminal 100 (S440).

Thereafter, the terminal 100 registers the coupon issued from the content management system 200 through an application (not illustrated) installed in advance on the terminal 100.

For example, the terminal registers (or keeps) a blue jean discount coupon issued from the content management system 200, through a coupon application (not illustrated) installed in advance on the terminal (S450).

Thereafter, the content management system 200 additionally issues predetermined one or more relevant product coupon to the terminal 100 in response to the coupon issued to the terminal 100. In this process, the issue of the relevant product coupons additionally to the terminal from the content management system 200 may be made right after the coupon corresponding to the individual information, or simultaneously with the issue of the corresponding coupon, or before a predetermined date from the expiration date of validity of the coupon on the basis of the term of validity of the coupon corresponding to the individual information.

For example, the contents management system 200 issues a T-shirt discount coupon that is a relevant product coupon kept in advance, in response to the blue jean discount coupon issued to the corresponding terminal 100. In this process, the content management system 200 issues the T-shirt discount coupon to the terminal 100 together (or simultaneously) with the blue jean discount coupon right after the blue jean discount coupon is issued to the terminal or at a specific date before predetermined days (for example, 10 days) from the expiration date of validity of the coupon (for example, on April 10, before 10 days from April 20 that is the expiration date) on the basis of the term of validity (for example, the expiration date is April 20) of the blue jean discount coupon (S460).

Thereafter, the terminal 100 registers the coupon and one or more relevant product relating to the coupon issued from the content management system 200 through an application installed in advance on the terminal 100.

Further, the terminal 100 uses the issued coupon and one or more relevant product coupons at a store (not illustrated) corresponding to the coupon or the one or more relevant product coupons.

For example, the terminal 100 registers the T-shirt discount coupon issued from the content management system 200 through a coupon application installed in advance on the terminal 100.

Further, the terminal 100 uses (or pays with) the blue jean discount coupon and the T-shirt discount coupon registered on the coupon application through a POS terminal (not illustrated) in a store corresponding to the blue jean discount coupon or the T-shirt discount coupon (S470).

A terminal and a content management system, and a system including the terminal and the content management system, according to an embodiment of the present invention, can be recorded in a computer program, and codes and code segments of the computer program can be easily inferred by computer programmers in the field. Further, the computer program is stored in computer readable media, and read and executed by a computer or a terminal, a content management system, and a cloud system according to an embodiment of the present invention, so the terminal and the content management system, and the system including the terminal and the content management system can be implemented.

The computer readable media include a magnetic recording medium, an optical recording medium, and a carrier wave medium. The computer program that implements the terminal and the content management system, and the system including the terminal and the content management system according to an embodiment of the present invention can be stored and installed in a built-in memory of the terminal, the content management system, the cloud system, and the like. Alternatively, an external memory such as a smart card where a computer program that implements the terminal and the content management system, and the system including the terminal and the content management system according to an embodiment of the present invention is stored and installed may be mounted on the terminal, the content management system, and the cloud system through an interface.

An embodiment of the present invention, as described above, can provide an efficient promotion in a specific area by sending out a pre-registered coupon and relevant product coupons corresponding to the coupon to a terminal sensed in a predetermined section, increase sale with additional promotions of relevant products, provides a function of managing poor stock, and improve usability as an offline promotion based on a beacon collection system.

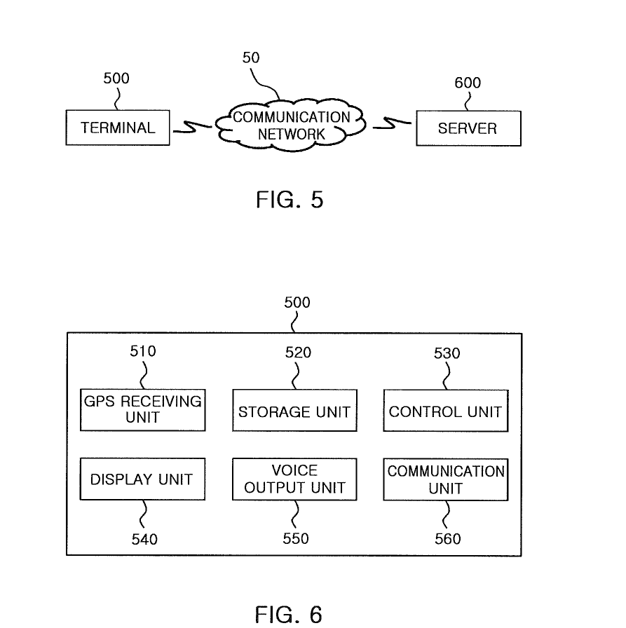

FIG. 5 is a block diagram illustrating the configuration of a system 50 according to another embodiment of the present invention.

As illustrated in FIG. 5, the system 50 includes a terminal 500 and a server 600. The components of the system 50 illustrated in FIG. 5 are not all necessary components, and the system 50 may be composed of components much or less than the components illustrated in FIG. 5.

When a product is searched through the terminal 500, the server 600 searches a plurality of items of store information from one or more stores corresponding to the location information of the terminal 500 on the basis of the product name (or product information), the price, a royalty program, additional services, the distance, discount coupons, or discount card information, and provides the searched store information to the terminal 500. In this process, the server 600 may search also store information of relevant products relating to the product name and provide the searched store information of the relevant products to the terminal 500. Thereafter, when any one of the items of store information is selected through the terminal 500, the corresponding terminal searches a path from the current location of the terminal 500 to the selected store and outputs the result of searching the path.

As illustrated in FIG. 6, the terminal 500 includes a GPS receiving unit 510, a storage unit 520, a control unit 530, a display unit 540, a voice output unit 550, and a communication unit 560. The components of the terminal 500 illustrated in FIG. 6 are not all necessary components, and the terminal 500 may be composed of components much or less than the components illustrated in FIG. 6.

The GPS receiving unit 510 receives a GPS signal from a satellite and generates location data of the terminal 500 in real time on the basis of longitude coordinates and latitude coordinates included in the received GPS signal. Herein, the location data is defined as the current location (or current location data) of the terminal 500. Herein, the location information may be received through not only the GPS receiving unit 510, but Wi-Fi or Wibro communication. Further, a location based technology usually uses GPS information that is a signal received by the GPS receiving unit 510, but a hybrid positioning system using both of cell tower signal triangulation and Wi-Fi positioning information, including GPS information, may be used.

Further, a signal received through the GPS receiving unit 510 may be configured to provide location information of the terminal 500 to the terminal, using wireless communication types such as 802.11 that is a warless network standard about a wireless LAN and a wireless network for a wireless LAN including some infrared communication under IEEE (Institute of Electrical and Electronics Engineers), 802.15 that is a standard about a wireless PAN (Personal Area Network) including Bluetooth, UWB, and Zigbee, 802.16 that is a standard about wireless MAN (Metropolitan Area Network)(Broadband Wireless Access BWA) including FWA (Fixed Wireless Access), and 802.20 that is a standard about mobile internet for wireless MAN (MBWA Mobile Broadband Wireless Access) including Wibro and WiMax.

In this way, the GPS receiving unit 510 creates current location data of the terminal 500. In this process, this function may be performed by the control unit 530.

The storage unit 520 keeps data and programs for operation of the terminal 500.

Further, the storage unit 520 keeps map data. In this process, the kept map data include geographic coordinates (or longitude/latitude coordinates) exhibiting a latitude and a longitude in DMS (Degree/Minute/Second) unit. Herein, the kept map data may use UTM (Universal Transverse Mercator) coordinates, UPS (Universal Polar System) coordinates, TM (Transverse Mercator) coordinates, and the like, other than the geographic coordinates. In this process, the map data to be kept in the storage unit 520 may be map data transmitted from a temporal server.

Further, the storage unit 520 keeps various items of information such as various menu images, point of interest (hereafter, referred to as POI), functional characteristic information according to specific positions in the map data.

Further, the storage unit 520 receives periodically/non-periodically various items of state information about roads (TPEG (Transport Protocol Expert Group) information including traffic information and accident information) from a certain server (for example, an information providing server or a call center) connected through the communication unit 560, and keeps the received various items of state information about roads.

Further, the storage unit 520 is controlled by the control unit 530 to keep discount coupon information and discount card information.

The control unit 530 controls the entire function of the terminal 500.

Further, the control unit 530 generates (or creates) the current estimated location of the terminal 500 (for location information of the terminal 500/current/real-time location information of the terminal 500) on the basis of the generated location data through the GPS receiving unit 510.

Further, the control unit 530 reads out map data corresponding to a running path kept in advance in the storage unit 520.

Further, the control unit 530 acquires matching map information (or map matching result) by matching the generated estimated location with links (roads) included in the read map data. For example, the control unit 530 generates an estimation location of the terminal 500 on the basis of the estimated location, matches the generated estimated location with the links in the map data kept in the storage unit 520 in order of the links, and acquires matching map information (map matching result). In this process, the matching map information (map matching result) is information created with reference to predetermined user information and road states using TPEG information. Herein, the TPEG information is information transmitted from an external information center (or server) (not illustrated) or a call center (not illustrated) connected through the communication unit 560.

Further, the control unit 530 creates navigation information on the basis of the matching map information. Herein, the created navigation information includes image information and a control signal. In this process, the image information includes one or more of map data, POI information, road (or sidewalk information), lane information, turn-by-turn list information, and the like. Further, the control signal includes a signal for controlling image information and voice information.

Further, the control unit 530 outputs the created navigation information through at least one of the display unit 540 and the voice output unit 550.

Further, when the product name (or product information) of a specific product is received by an input unit (not illustrated) or the display unit 540, the control unit 530 transmits the product name, discount coupon or discount card information registered (or kept/issued) in advance on the terminal 500 in connected with the product (or the product name), the location information of the terminal 500, and the identification information of the terminal 500 to the server 600 through the communication unit 560. Herein, the identification information of the terminal 500 includes an MDN (Mobile Directory Number), a mobile IP, a mobile MAC, specific information of a SIM (subscriber identity module) card, and a serial number.

Further, the control unit 530 receives a plurality of items of store information searched in correspondence to the product name, which is transmitted from the server 600 in response to the transmitted information (for example, including the product name, the discount coupon or discount card information, the location information of the terminal 500, and the identification information of the terminal 500), and a plurality of items of other store information searched in correspondence to relevant products relating to the product name, through the communication unit 560. Herein, the store information or the other store information includes store names, one or more product names (or product information) in stores, identification information of stores, image information about stores, location information of stores, phone number information of stores, and homepage addresses (or SNS information) of stores.

Further, the control unit 530 displays the plurality of items of store information searched in correspondence to the received product name and the plurality of items of other store information searched in correspondence to the relevant products relating to the product name on the display unit 540.

Further, when any one item of store information in the plurality of items of store information searched in correspondence to the corresponding product name and the plurality of items of other store information searched in correspondence to the relevant products relating to the product name displayed on the display unit 540 is selected by selection (or control/operate) of the user of the terminal 500, the control unit 530 searches a path on the basis of the selected store information corresponding to destination information, the real-time current location information of the terminal 500, and the like.

That is, when any one item of store information in the plurality of items of store information searched in correspondence to the corresponding product name and the plurality of items of other store information searched in correspondence to the relevant products relating to the product name displayed on the display unit 540 is selected by selection (or control/operate) of the user of the terminal 500, the control unit 530 searches a path from the current location of the terminal 500 to the location of the store corresponding to the selected store information on the basis of the selected store information and the current location of the terminal 500.

Further, the control unit 530 outputs the result of searching a path through the display unit 540 and/or the voice output unit 550. Herein, the result of searching a path may include various items of information relating to movement to the destination such as the map data, the location information of the store corresponding to the destination and the selected store information, the current location information of the terminal, lane information (or road information), and traffic safety information. Further, the result of searching a path may include information about map data for walking or map data for driving.

Although a path is searched on the basis of the store information selected by the terminal 500 and the location information of the terminal 500 (or the real-time current location information of the terminal 500), the present invention is not limited thereto. Accordingly, when any one item of store information in the plurality of items of store information searched in correspondence to the corresponding product name and the plurality of items of other store information searched in correspondence to the relevant products relating to the product name displayed on the display unit 540 is selected, the control unit 530 may transmit the selected store information, the current location information of the terminal 500, and the identification information of the terminal 500 to the server 600 through the communication unit 560, the server 600 may search a path on the basis of the selected store information and the location information of the terminal 500, the result of searching a path may be transmitted to the terminal 500 from the sever 600, and the result of searching a path transmitted from the terminal 500 to the sever 600 may be outputted through the display unit 540 and/or the voice output unit 550.

The display unit 540 can be controlled by the control unit 530 to display contents such as a menu image, using a user interface and a graphic user interface in the storage unit 520. Herein, the contents that are displayed on the display unit 540 include a text or image data (including various data) and an icon, and a menu screen including a list menu and a combo box. Further, the display unit 540 may be a touch screen.

Further, the display unit 540 is controlled by the control unit 530 to display image information included in the created navigation information. Herein, the image information includes information resulted from navigation such as map data, POI information, road (or sidewalk information), lane information, turn-by-turn list information, and road information for walking/climbing/taking a walk.

Further, the display unit 540 is controlled by the control unit 530 to display the result of searching a path.

The voice output unit 550 is controlled by the control unit 530 to output voice included in a signal that has undergone predetermined signal processing. Herein, the voice output unit 550 may be a speaker.

Further, the voice output unit 550 is controlled by the control unit 530 to output the created navigation information and the voice information included in the result of searching a path.

The communication unit 560 communicates with internal components or at least one external terminal through a wire/wireless communication network. In this process, the external terminal may include an information providing server, a call center, and the server 600.

Further, the communication unit 560 is controlled by the control unit 530 to receive TPEG information.

Further, the communication unit 560 is controlled by the control unit 530 to transmit/receive various data (or information) to/from the server 600.

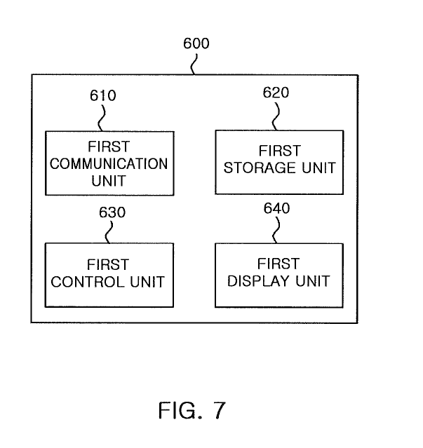

As illustrated in FIG. 7, the server 600 includes a first communication unit 610, a first storage unit 620, a first control unit 630, and a first display unit 640. The components of the server 600 illustrated in FIG. 7 are not all necessary components, and the server 600 may be composed of components much or less than the components illustrated in FIG. 7.

The first communication unit 610 communicates with the terminal 500 in wire/wireless communication type.

Further, the first communication unit 610 is controlled by the first control unit 630 to receive a product name transmitted from the terminal 500, a discount coupon or discount card information registered (or kept in/issued from) in advance on the terminal 500 in relation to a product (or the product name), the location information of the corresponding terminal 500, and the identification information of the terminal 500. Herein, the identification information of the terminal 500 includes an MDN, a mobile IP, a mobile MAC, specific information of the Sim (subscriber identity module) card, and a serial number.

Further, the first communication unit 610 is controlled by the first control unit 630 to transmit a plurality of items of store information searched in correspondence to the corresponding product name and a plurality of items of other store information searched in correspondence to relevant products relating to the product name to the terminal 500.

The first storage unit 620 keeps data and programs for operation of the server 600.

Further, the first storage unit 620 is controlled by the first control unit 630 to keep the kind a coupon issued to the terminal 500, the number of issue of the coupon, discount coupon information, and discount card information.

Further, the first storage unit 620 is controlled by the first control unit 630 to keep store information of a plurality of stores. Herein, the store information (or other store information) includes store names, one or more product names (or product information) in stores, identification information of stores, image information about stores, location information of stores, phone number information of stores, and homepage addresses (or SNS information) of stores.

The first control unit 630 controls the entire function of the server 600.

Further, the first control unit 630 receives a product name transmitted from the terminal 500, a discount coupon or discount card information registered (or kept in/issued from) in advance on the terminal 500 in relation to a product (or the product name/a product corresponding to the product name), the location information of the terminal 500, and the identification information of the terminal 500 through the first communication unit 610.

Further, the first control unit 630 searches a plurality of items of store information in a plurality of items of store information registered (or kept in) in advance on the first storage unit 620 on the basis of the received product name, the discount coupon or discount card information relating to the corresponding product, the location information of the terminal 500, the price information of the product corresponding to the product name, royalty program information (for example, including additional discount information and reserve mileage information), additional service information (for example, including sales promotion information), and the distance (or estimated time of arrival). In this process, the first control unit 630 may search one or more items of store information in a section (or a geo-fence object section) corresponding to the information of the store, where the terminal 500 is positioned, in the plurality of items of store information (or the location information of the terminal 500). Herein, the store information includes store names, one or more product names (or product information) in stores, identification information of stores, image information about stores, location information of stores, phone number information of stores, and homepage addresses (or SNS information) of stores.

That is, the first control unit 630 checks one or more items of store information in the section corresponding to the received location information of the terminal 500, in the plurality of items of store information registered in advance on the first storage unit 620. Further, the first control unit 630 searches a plurality of items of store information in one or more items of store information in the section corresponding to the checked location information of the terminal 500, on the basis of the received product name, the discount coupon or discount card information relating to the product, the price information of the product corresponding to the product name, royalty program information (for example, including additional discount information and reserve mileage information), additional service information (for example, including sales promotion information), and the distance (or estimated time of arrival).

Further, when searching the store information relating to the product (or product mane), the first control unit 630 searches also the store information of relevant products relating to the product (or product name).

Although the discount coupon information or the discount card information relating to the product is provided from the terminal 500 to the server in an embodiment of the present invention, the present invention is not limited thereto, and the server 600 may check the discount coupon information or the discount card information through the server 600, without receiving it from the terminal 500, on the basis of the discount coupon and discount card information issued to the terminal 500 kept in the second storage unit 620.

Further, the first control unit 630 transmits a plurality of items of store information searched in correspondence to the product name and a plurality of items of other store information searched in correspondence to relevant products relating to the product name to the terminal 500 through the first communication unit 610.

The first display unit 640 can be controlled by the first control unit 630 to display contents such as a menu image, using a user interface and a graphic user interface in the first storage unit 620. Herein, the contents that are displayed on the first display unit 640 include a text or image data (including various data) and an icon, and a menu screen including a list menu and a combo box. Further, the first display unit 640 may be a touch screen.

Further, the first display unit 640 is controlled by the first control unit 630 to display a plurality of items of store information searched in correspondence to the product name and a plurality of items of other store information searched in correspondence to relevant products relating to the product name.

As described above, it is possible to provide information about one or more stores corresponding to the searched product on the basis of the price when the product is searched, additional services, the distance to move for purchasing, a royalty program of an additional discount and a mileage, information about stores having relevant products, and the like.

Further, it is possible to provide navigation information about a specific store selected by a user in provided information about one or more stores.

A method of controlling a system according to the present invention will be described hereafter in detail with reference FIGS. 5 to 9.

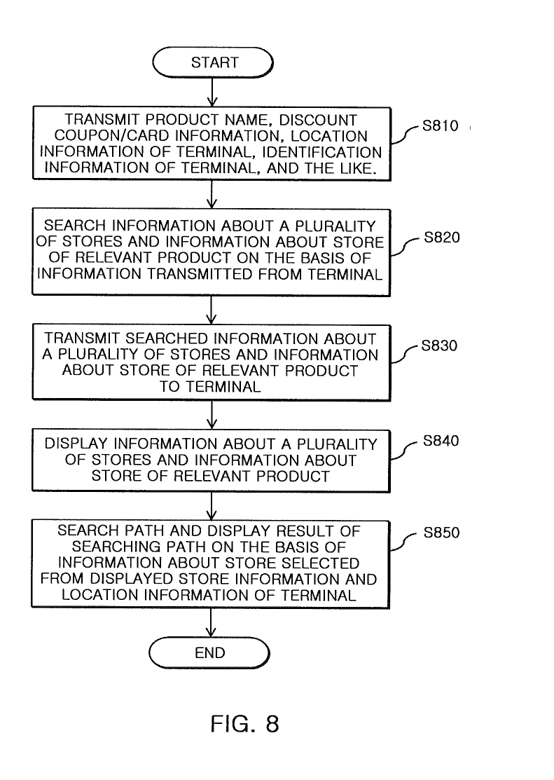

FIG. 8 is a flowchart illustrating a method of controlling a system according to an embodiment of the present invention.

First, when the terminal 500 receives the name of a specific product, the terminal 500 transmits the product name, discount coupon or discount card information registered (or kept in/issued to) in advance on the terminal 500 in relation to the product (or the product name/the product corresponding to the product name), the location information of the terminal 500, and the identification information of the terminal 500 to the server 600. Herein, the location information of the terminal 500 corresponds to the location of the terminal 500 that is checked in real time through the GPS receiving unit 510 in the terminal 500. Further, the identification information of the terminal 500 includes an MDN, a mobile IP, a mobile MAC, specific information of the Sim (subscriber identity module) card, and a serial number.

For example, when the terminal 500 receives a product name AA by input of the user of the terminal 500 (or touch of the user), the terminal 500 transmits the product name AA, discount coupon information registered in advance on the terminal 500 in relation to the product AA, the location information of the terminal 500, and the identification information of the terminal 500 to the server 600 (S810).

Thereafter, the server 600 receives the product name transmitted from the terminal 500, the discount coupon or discount card information registered (or kept in/issued from) in advance on the terminal 500 in relation to the product (or the product name), the location information of the terminal 500, and the identification information of the terminal 500.

Further, the server 600 searches a plurality of items of store information in store information (or a plurality of stores) registered (or kept in) in advance on the server 600 on the basis of the received product name, the discount coupon or discount card information relating to the product, the location information of the terminal 500, the price information of the product corresponding to the product name, royalty program information (for example, including additional discount information and reserve mileage information), additional service information (for example, including sales promotion information), and the distance (or estimated time of arrival). In this process, the server 600 may search one or more items of store information in a section (or a geo-fence object section) corresponding to the information of the store, where the terminal 500 is positioned, in the plurality of items of store information (or the location information of the terminal 500). Herein, the store information includes store names, one or more product names (or product information) in stores, identification information of stores, image information about stores, location information of stores, phone number information of stores, and homepage addresses (or SNS information) of stores.

That is, the server 600 checks one or more items of store information in the section corresponding to the received location information of the terminal 500, in the plurality of items of store information registered in advance on the server 600. Further, the server 600 searches a plurality of items of store information in one or more items of store information in the section corresponding to the checked location information of the terminal 500, on the basis of the received product name, the discount coupon or discount card information relating to the product, the price information of the product corresponding to the product name, royalty program information (for example, including additional discount information and reserve mileage information), additional service information (for example, including sales promotion information), and the distance (or estimated time of arrival).

In this process, the server 600 searches also the store information of relevant products relating to the product (or the product name).

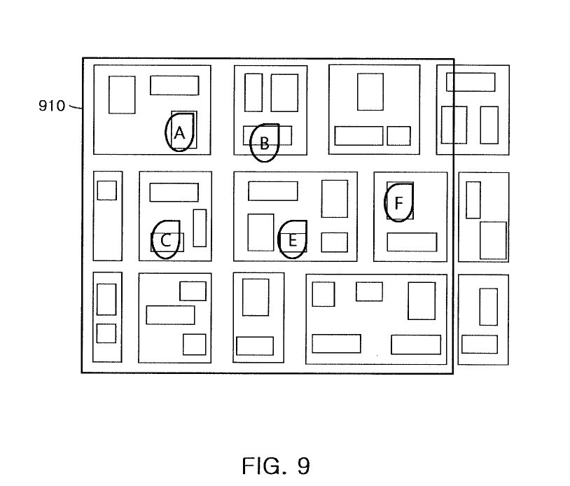

For example, as illustrated in FIG. 9, when the server 600 searches the information about the stores A to E corresponding to the product name on the basis of the received product name AA, discount coupon information relating to the product AA, the price information of the product AA, loyalty program information including additional discount information, additional service information, and the information about the distance based on the location information of the terminal 500, in one or more items of store information in the section 910 corresponding to the location information of the terminal 500.

Further, the server 600 searches the information about one or more stores F corresponding to the product BB on the basis of the price information of a product BB, which is a relevant product relating to the received product name AA, loyalty program information including additional discount information, additional service information, and the information about the distance based on the location information of the terminal 500, in one or more items of store information in the section 910 corresponding to the location information of the terminal 500 (S820).

Thereafter, the server 600 transmits the plurality of items of store information searched in correspondence to the received product name and the plurality of items of other store information searched in correspondence to the relevant products relating to the product name to the terminal.

For example, the server 600 transmits the information about the stores A to E searched in correspondence to the product name AA and the information of the store F searched in correspondence to the product BB that is a relevant product relating to the product name AA to the terminal 500 (S830).

Thereafter, the terminal 500 receives a plurality of items of store information searched in correspondence to the product name, which is transmitted from the server in response to the information transmitted to the server 600 (for example, including the product name, discount coupon or discount card information registered (or kept in/issued to) in advance on the terminal in connection with the product (or product name), the location information of the terminal 500, and the identification information of the terminal 500), and a plurality of items of other store information searched in correspondence to relevant products relating to the product name.

Further, the terminal 500 displays the plurality of items of store information searched in correspondence to the received product name and the plurality of items of other store information searched in correspondence to the relevant products relating to the product name.

For example, the terminal 500 displays the information about the stores A to E searched in correspondence to the product name AA and the information of the store F searched in correspondence to the product BB that is a relevant product relating to the product name AA (S840).

Thereafter, when any one item of store information in the plurality of items of store information searched in correspondence to the corresponding product name and the plurality of items of other store information searched in correspondence to the relevant products relating to the product name displayed on the terminal 500 is selected by selection (or control/operate) of the user of the terminal 500, the terminal 500 searches a path from the current location of the terminal 500 to the location of the store corresponding to the selected store information on the basis of the selected store information and the current location of the terminal 500.

Further, the terminal 500 outputs the result of searching a path. Herein, the result of searching a path may include various items of information relating to movement to the destination such as the map data, the location information of the store corresponding to the destination and the selected store information, the current location information of the terminal, lane information (or road information), and traffic safety information. Further, the result of searching a path may include information about map data for walking or map data for driving.

For example, when the information about the store C is selected from the information about the stores A to E searched in correspondence to the product name AA displayed on the terminal 500 and the information of the store F searched in correspondence to the product BB that is a relevant product relating to the product name AA, the terminal 500 performs the function of searching a path from it current location to the location of the store C (or location information) corresponding to the information of the selected store C, and outputs the result of searching a path (S850).

A terminal and a server, and a system including the terminal and the server, according to an embodiment of the present invention, can be recorded in a computer program, and codes and code segments of the computer program can be easily inferred by computer programmers in the field. The computer program is stored in computer readable media, and read and executed by a computer or a terminal and a server according to an embodiment of the present invention, so the terminal and the server, and a system including the terminal and the server can be implemented.

The computer readable media include a magnetic recording medium, an optical recording medium, and a carrier wave medium. A computer program for achieving a terminal and a server, and a system including the terminal and the server, according to an embodiment of the present invention may be stored and installed in a built-in memory of the terminal and the server. Alternatively, an external memory such as a smart card in which a computer program for achieving a terminal and a server, and a system including the terminal and the server according to an embodiment of the present invention is stored and installed may be mounted on the terminal and the server through an interface.

An embodiment of the present invention provides information about one or more stores corresponding to a searched product on the basis of the price when the product is searched, additional services, the distance to move for purchasing, a royalty program of an additional discount and a mileage, and information about stores having relevant products, so the present invention can be used for a recommendation system in an offline store and accordingly, cross-selling among stores can be achieved.

Further, as described above, an embodiment of the present invention provides a navigation service for a specific store selected by a user from the information about one or more stores, so it is possible to measure foot traffic of all of users in a specific area or in a wide region and use the measured data for target marketing.

It should be understood that the present invention may be changed and modified by those skilled in the art without departing from the scope of the present invention. Accordingly, the embodiment described herein are provided not to limit, but to explain the spirit of the present invention and the spirit and the scope of the present invention are not limited by the embodiments. The protective range of the present invention should be construed on the basis of claims and all the technical spirits in the equivalent range should be construed as being included in the scope of the right of the present invention.

The present invention can provide an efficient promotion in a specific area by sending out a pre-registered coupon and relevant product coupons corresponding to the coupon to a terminal sensed in a predetermined section, increase sale with additional promotions of relevant products, provides a function of managing poor stock, and improve usability as an offline promotion based on a beacon collection system, so it can be used in various fields including fields of terminal, beacon collection system, and advertisement/publicity.

Further, the present invention provides information about one or more stores corresponding to the searched product on the basis of the price when the product is searched, additional services, the distance to move for purchasing, a royalty program of an additional discount and a mileage, and information about stores having relevant products and provides navigation information about a specific store selected by a user in provided information about one or more stores. Accordingly, it can be used as a recommendation system in an offline store, can allow cross-selling among stores, can measure foot traffic of all of users in a specific area or in a wide region, and can use the measured data for target marketing. Therefore, the present invention can be used in various fields including fields of terminal, beacon collection system, and advertisement/publicity.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A content management system comprising:
a storage unit that keeps a plurality of coupons and a plurality of relevant product coupons;
a sensing unit that senses a terminal entering a predetermined section;
a communication unit that communicates with the sensed terminal, receives identification information of the terminal transmitted from the terminal, and transmits the received identification information of the terminal to a could system; and
a control unit that, on the basis of individual information transmitted from the cloud system in response to the transmitted identification information of the terminal, checks a coupon corresponding to the received individual information in the plurality of kept coupons, issues the checked coupon to the terminal, and additionally issues one or more relevant product coupons, which correspond to the coupon issued to the terminal, to the terminal.

2. The content management system of claim 1, wherein the control unit issues a coupon corresponding to age and sex included in the individual information in the plurality of kept coupons to the terminal.

3. The content management system of claim 1, wherein the control unit issues the one or more relevant product coupons right after the coupon corresponding to the individual information is issued, or issues the one or more relevant product coupons together with the coupon corresponding to the individual information, or issues the one or more relevant product coupons before a predetermined date from an expiration date of the coupon on the basis of the term of validity of the coupon corresponding to the individual information.

4. A terminal comprising:
a GPS receiving unit that generates current location information of the terminal;
a storage unit that keeps discount coupon information and discount card information;
a communication unit that communicates with a server;
a control unit that, when receiving a product name of a product, transmits the product name, discount coupon or discount card information kept in advance in the storage unit in connection with the product name, current location information of the terminal, and identification information of the terminal to the server, and that receives a plurality of items of store information searched in correspondence to the product name transmitted from the server and a plurality of items of other store information searched in correspondence to relevant products relating to the product name; and
a display unit that the received store information searched in correspondence to the product name and the other store information searched in correspondence to relevant products relating to the product name.

5. The terminal of claim 4, wherein the store information or the other store information includes at least one of store names, one or more product names or product information in stores, identification information of stores, image information about stores, location information of stores, phone number information of stores, and homepage addresses of stores.

6. The terminal of claim 4, wherein when one item of store information is selected from the store information searched in correspondence to the product name and the other store information searched in correspondence to relevant products relating to the product name, which are displayed on the display unit, the control unit searches a path on the basis of the selected store information and current location information of the terminal checked in real time through the GPS receiving unit, and controls the display unit to display the result of searching a path.

7. A server comprising;
a storage unit that keeps one or more items of store information;
a communication unit that receives a product name of a product transmitted from a terminal, discount coupon or discount card information relating to the product, location information of the terminal, and identification information of the terminal; and
a control unit that searches a plurality of items of store information in the store information kept in the storage unit on the basis of the received product name, the discount coupon or discount card information relating to the product, location information of the terminal, price information of the product corresponding to the product name, royalty program information, additional service information, and a distance, and searches a plurality of items of other store information corresponding to the relevant products relating to the product in the store information kept in the storage unit.

8. The server of claim 7, wherein the control unit searches a plurality of items of store information in one or more items of store information in a section corresponding to location information of the terminal in the store information kept in the storage unit on the basis of the received product name, the discount coupon or discount card information relating to the product, price information of the product corresponding to the product name, royalty program information, additional service information, and a distance.

9. The server of claim 7, wherein the communication unit transmits a plurality of items of store information search in correspondence to the product name and a plurality of items of other store information searched in correspondence to the relevant products relating to the product name to the terminal.
